(19) United States
(12) Patent Application Publication
(10) Pub. No.: US 2018/0322639 A1
(43) Pub. Date: Nov. 8, 2018

(54) METHOD FOR TRACKING A CLINICAL TARGET IN MEDICAL IMAGES

(71) Applicants: B<>COM, Cesson Sevigne (FR); INRIA, Le Chesnay (FR); Institut National Sciences Appliquees, Rennes (FR)

(72) Inventors: Lucas Royer, Rennes (FR); Alexandre Krupa, Chasne Sur Illet (FR); Maud Marchal, Cesson Sevigne (FR)

(21) Appl. No.: 15/773,403

(22) PCT Filed: Oct. 28, 2016
(86) PCT No.: PCT/FR2016/052820

§ 371 Date: May 3, 2018

(30) Foreign Application Priority Data
Nov. 3, 2015 (FR) 15 60541

(51) Int. Cl. G06T 7/20; G06T 7/12; G06T 7/143

(52) U.S. Cl. CPC G06T 7/20; G06T 7/12; G06T 7/143; G06T 2207/10016; G06T 2207/10132; G06T 2207/20116; G06T 2207/10068

(57) ABSTRACT

A method of tracking a clinical target in a current image of a sequence of digital medical images, with respect to a reference image of the sequence. The method includes: obtaining a segmentation of a contour of the target from the reference image; determining a region delimiting the interior of the segmented contour of the target in the reference image; obtaining a confidence measurement per image element in the determined region for the reference and current images; deforming the contour by minimising a cost function based on an intensity difference between the current and reference images in the determined region, the cost function being weighted by the confidence measurements; and adapting the reference image at least from the intensities of the current image and the current image confidence measurements in the target region, the cost function taking into account the intensities of the adapted reference image.

### 1. CROSS-REFERENCE TO RELATED APPLICATIONS

This Application is a Section 371 National Stage Application of International Application No. PCT/FR2016/052820, filed Oct. 28, 2016, the content of which is incorporated herein by reference in its entirety, and published as WO 2017/077224 on May 11, 2017, not in English.

### 2. FIELD OF THE INVENTION

The field of the invention is that of the processing of medical images.

More specifically, the invention relates to a method for tracking a clinical target in a sequence of medical digital images.

The invention finds particular application in the processing of images obtained by an ultrasound or endoscopic imaging technique.

### 3. STATE OF THE ART

The ultrasonic or endoscopy imaging technique are widely used in the medical field for helping doctors to visualize in real time a clinical target and/or a surgical tool during a surgical procedure or an invasive examination intended to diagnose a pathology. For example, ultrasound techniques are frequently used during an intervention requiring the insertion of a needle, and especially in interventional radiology.

It is sometimes difficult for a surgeon to locate by himself certain clinical targets, such as tumors, in an image obtained by an ultrasound or endoscopic imaging technique. In order to assist him, tools for automatically estimating the position of a surgical target in an ultrasound image have been made availabe to surgeons.

However, it can be noted that during the acquisition of a sequence of images, dark or light aberrations, such as shadow, halos, specularities or occlusions may appear on the current image and disturb the tracking of a target.

For example, shadow regions are frequently observed in image sequences obtained by ultrasound imaging technique or halos/specularities in image sequenes obtained by endoscopy, which can strongly alter the contrast of the images at the target and, in some cases, at least partially obscure the target.

To improve the accuracy and robustness of algorithms for processing images showing aberrations, it has been proposed to draw up beforehand a confidence map of pixels or voxels of a current image, to distinguish the regions of image with aberrations. This confidence map is formed of local confidence measurements estimated for the pixels or voxels of the current image. Each of these local confidence measurements corresponds to a value indicative of a probability or likelihood that the intensity of the pixel/voxel with which it is associated represents an object and is not affected by different disturbances such as, for example, shadows, specular reflections or occultations generated by the presence of other objects.

For example, the article by Karamalis et al “Ultrasonic confidence map using random walks”, Medical Image Analysis, 16(2012) pp. 1101-1112, ed. Elsevier, discloses a method for calculating a confidence map of pixels or voxels of a current image, intended to be exploited to re-adjust images.

In particular, in the thesis by A. Karamalis (“Ultrasound confidence maps and application in medical image processing”, Faculty of Computer Science of Technical University of Munich, 2013), it is proposed to use this confidence map for tracking a target based on the intensity of the pixels or voxels of the target, for example based on a cost function of the type SSD (“Sum of Squared Difference”).

A shortcoming of this cost function lies in that it is not robust to changes in illumination, or gain that may occur during acquisition.

It is not very efficient either in case when aberration is very important in terms of intensity or very extensive in the image.

### 4. SUMMARY OF THE INVENTION

These objectives, and others that will appear later using a method for tracking a clinical target in a current image of a sequence of digital medical images, obtained by an ultrasound or endoscopic imaging technique, with respect to a reference image of said sequence, comprising the following steps:
obtaining a segmentation of a contour of said target from said reference image;
determining a region delimiting the interior of the segmented contour of the target in said reference image;
obtaining a confidence measurement per image element in said determined region for said reference image and for said current image;
deforming said contour obtained by minimising a cost function based on an intensity difference between the current image and the reference image in the determined region, said cost function being weighted by the confidence measurements obtained for the image elements of said determined region;

According to the invention, such a method for tracking a clinical target further comprises a step of adapting the reference image at least from the intensities of the current image and the confidence measurements of the current image in the target region and the cost function takes into account the intensities of the adapted reference image.

Thus, in an unprecedented and particularly shrewd way, the invention proposes to use the confidence measurements in the intensities of the current image to adapt the intensities of the reference image in the target region and thus to evaluate more precisely the relevant intensity difference to deform the contour of the target.

According to a particular aspect of the invention, said cost function takes into account a weighting of the combined probability density of the intensities of the current image and the reference image by said confidence measurements.

In a particular embodiment of the invention, a method for tracking a clinical target as described above, further comprises a step of detecting at least one aberration portion in said reference image and in said current frame and in that said aberration portion detected is taken into account in said step of obtaining a measurement of confidence in said specific region for said reference image and said current image.

According to a particular aspect of the invention, the contour deformation further takes into account a mechanical model of internal deformation of the target for correcting said deformation resulting from the minimisation of a cost function and in that the deformation of the contour resulting from the minimisation of a cost function with respect to the deformation resulting from the mechanical model of internal deformation of the target in the target region is weighted.

The method which has just been described in its different embodiments is advantageously implemented by a device for tracking a clinical target in a current image of a sequence of digital medical images, obtained by an ultrasound or endoscopic imaging technique, with respect to a reference image of said sequence, a digital image comprising image elements, comprising the following units:
a unit for obtaining a segmentation of a contour of said target from said reference image;
a unit for determining a region delimiting the interior of the segmented contour of the target in said reference image;
a unit for obtaining a confidence measurement per image element in said determined region for said reference image and for said current image;
a unit for adapting the reference image at least from the intensities of the current image and confidence measurements of the current image in the region of the target
a unit for deforming said contour by minimising a cost function based on an intensity difference between the current image and the reference image in the determined region, said cost function being weighted by the confidence measurements obtained for the image elements of the region and taking into account the intensities of the adapted reference image.

The invention further relates to a computer program comprising instructions for implementing the steps of a method for tracking a clinical target as described above, when this program is executed by a processor.

This program can use any programming language. It can be downloaded from a communication network and/or recorded on a computer-readable medium.

The invention finally relates to a processor-readable recording medium, integrated or not to the device for tracking a clinical target according to the invention, optionally removable, storing a computer program implementing the method for tracking a clinical target as described above.

### 5. LIST OF FIGURES

Other features and advantages of the invention will become evident on reading the following description of one particular embodiment of the invention, given by way of illustrative and non-limiting example only, and with the appended drawings among which:

FIG. 1 is a synoptic representation, in diagrammatic form, of the steps of an exemplary method for tracking a clinical target according to the invention;

FIG. 2 is a view of a segmented contour of a target in a reference image;

FIG. 3 is a view of an image of a confidence measurement map; and

FIG. 4 shows schematically an example of the hardware structure of a device for tracking a clinical target according to the invention.

### 6. DETAILED DESCRIPTION OF THE INVENTION

### 6.1. Reminder of the Principle of Invention

As already stated, the principle of the invention relies especially on a strategy for tracking a target in a sequence of medical images based on an intensity-based approach of the deformations of the outer contour of the target, which takes into account the image aberrations by weighting the cost function used in the intensity-based approach according to a confidence measurement of voxels. Advantageously, this intensity-based approach can be combined with a mechanical model of the internal deformations of the target to allow robust estimation of the position of the outer contour of the target.

### 6.2 Exemplary Embodiment of the Invention

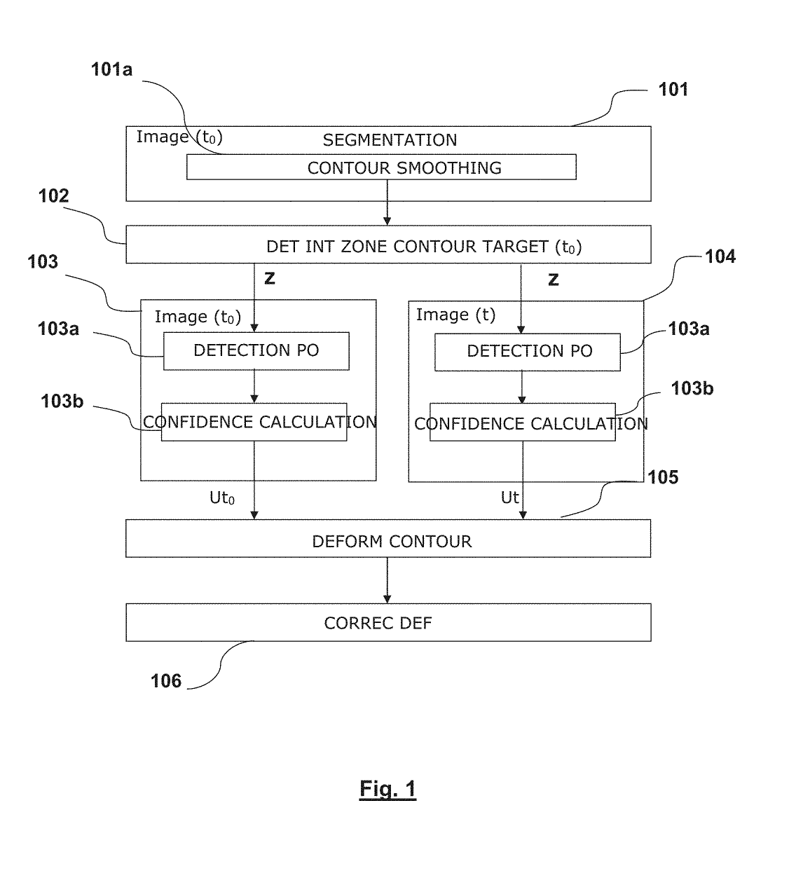

With reference to FIG. 1, the steps of an exemplary method for tracking a clinical target in a sequence of images according to the invention are schematically illustrated in block diagram form.

In this particular embodiment of the invention, the image sequence is obtained by ultrasound imaging. It is a sequence of three-dimensional images, the elements of which are voxels.

In a first step 101, segmentation of the target is carried out in the initial image of the sequence of 3D medical images, also called reference image in the following description, by a segmentation method known per se, which can be manual or automatic. In a step 101a, the contour of the segmented target is then smoothed to remove sharp edges and discontinuities of shape having appeared on its contour.

In a following step 102, a region (Z) delimiting the segmented contour of the target is determined in the reference image. To do this we construct a representation of the interior of the contour of the target, for example by generating a tetrahedral mesh.

A example of the region Z mesh is illustrated in FIG. 2. This figure corresponds to an ultrasound image comprising a target partly located in a white-hatched, shaded region. In this example, the mesh of the region Z has N_{c} vertices defining tetrahedral cells. Region Z has a total of N_{υ} voxels.

To calculate the deformation of tetrahedral cells making up the target, we will use a piecewise affine function connecting the positions of N_{υ} voxels with the positions of the N_{c} (N=60) vertices of the mesh, expressed in the form p=M·q, where p is a vector, of dimension (3.N)×1, representing the positions of the N_{υ} voxels of the target, q is a vector, of dimension (3.N_{c})×1, representing the positions of the N_{c} vertices of the mesh, and M is a matrix with constant coefficients, of dimension (3.N_{υ})×(3.N_{c}), defining a set of barycentric coordinates. In a step 103, a confidence measurement per voxel in the region Z of the reference image taken at time t₀, is then estimated for example according to the method described by Karamalis et al. (“Ultrasonic confidence map using random walks”, Medical Image Analysis, 16(2012) pp. 1101-1112, ed. Elsevier). In this paper we measure the confidence of a pixel/voxel of the ultrasound image as the probability that a random walk starting from this pixel/voxel reaches the transducers of the ultrasound probe. The path is constrained by the model of propagation of an ultrasonic wave in the soft tissues. The value of the confidence measurement that is assigned to each voxel during step 103 ranges between 0 and 255.

With this method, low values of the confidence measurements (<20) are assigned to the intensity of each voxel located in a shaded portion PO of the region Z, such as that shown hatched in FIG. 2.

It will be understood that this method for measuring a confidence value of the intensities of the elements of the image gives an indication of the location of any outliers in the region of the target.

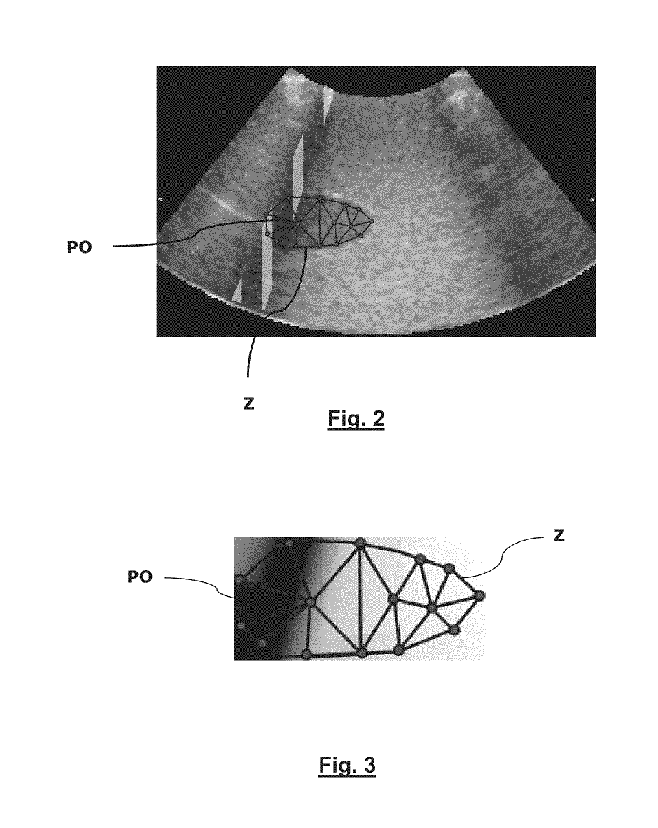

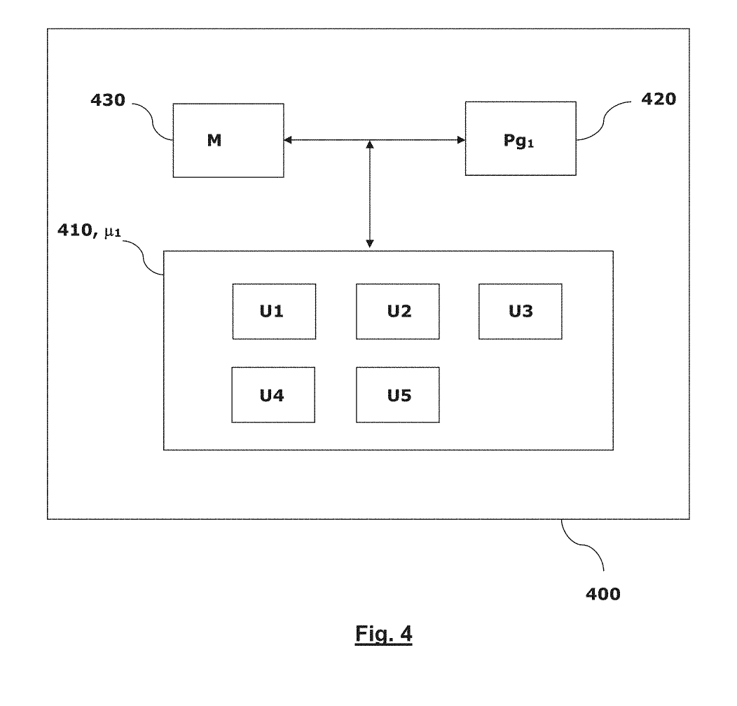

An example of an image of a confidence map Uₜ obtained for region Z is illustrated in FIG. 3. On this figure, the higher the confidence value of a voxel, the brighter it is.

In a step 104, a confidence measurement is calculated per voxel in the region Z of the current image of the sequence, taken at time t, according to the same method as that of step 103. This step is implemented for each new current image.

Note that unlike step 104, step 103 need not be repeated when processing a new current image because the reference image remains unchanged.

In this particular embodiment of the invention, during steps 103 and 104, the shaded portions of region Z are first detected at step 103a.

The step 103a for detecting the shaded portions of region Z implements a technique known per se, for example described in the document by Pierre Hellier et al, entitled «An automatic geometrical and statistical method to detect acoustic shadows in intraoperative ultrasound brain images» in the journal Medical Image Analysis, published by Elsevier, in 2010, vol. 14 (2), pp. 195-204. This method involves analysing ultrasound lines to determine positions corresponding to noise and intensity levels below predetermined thresholds.

For the detection of bright parts, such as halo or specularity, reference will be made, for example, to the detection technique described in the document by Morgand et al entitled “Generic and real-time detection of specularities”, published in the Proceedings of the Francophone Days of Young Computer Vision Researchers, held in Amiens in June 2015. The specularities of an endoscopic image are detected by dynamically thresholding the image in the HSV space for Hue-Saturation-Value. The value of the thresholds used is estimated automatically according to the overall brightness of the image.

Then in 103b, in a second step, a measurement of confidence is calculated for each voxel taking into account the part of the region where it is situated. For example, a bit mask is applied to the intensities of the target region. Voxels belonging to an outlier will get zero confidence and voxels outside an outlier will get a confidence measurement of 1.

It is understood that the confidence measurement will be lower if it is in a part detected as an outlier, such as a shaded portion for an ultrasound image or a specularity or halo for an endoscopic image.

According to another variant of this embodiment of the invention, the confidence measurement is calculated for the vertices of the tetrahedral cells rather than for the voxels. This value can be estimated by averaging the confidence of the voxels near the top position. An advantage of this variant is to be simpler and less computationally, given that the target region comprises fewer vertices that voxels. In a step 105, an intensity-based approach is implemented to calculate displacements of the contour of the target, by minimising a cost function C expres

C(Δq)=(Hₜ(Iₜ(p(t))−\hat{I}ₜ_{₀}^{t}(p(t₀)))))²

in which:
Δq is the vector of the displacements of the vertices of the contour of the target;
Hₜ is a diagonal matrix (N_{υ}, N_{υ}) calculated from the image of the confidence map Uₜ;
p(t) is the vector of the positions of voxels at time t;
Iₜ is a vector representing the intensity of the current image at time t;
Îₜ_{₀}^{t} is a vector representing the intensity of the reference image at time t.

For each position pₓ of a voxel of the adapted reference image, Îₜ_{₀}^{t} (Ix) is calculated from the following expression:

$${\hat{I}}_{{t}_{0}}^{t} ( {p}_{x} ( {t}_{0} ) ) = {\sum }_{i = 0}^{L - 1} i \frac{{pI}_{i} {I}_{{t}_{0}} ( i , j )}{{pI}_{i} ( j )} if {I}_{{t}_{0}} ( {p}_{x} ) = j ,$$

where:
L represents the gray level number of the current image and the reference image;
P_{I}_{ₜ} (j) is the probability density of Iₜ and is expressed as:

$${pI}_{t} ( j ) = {\sum }_{i = 0}^{L - 1} {pI}_{t} {I}_{{t}_{0}} ( i , j )$$

P_{I}_{ₜ}tₜ_{₀} is the joint probability density function of Iₜ and Iₜₒ, expressed in the form:

$${pI}_{t} {I}_{{t}_{0}} ( i , j ) = {\sum }_{k = 1}^{{N}_{x}} {H}_{t} ( {p}_{k} ( t ) ) {δ}_{i} ( {I}_{t} ( {p}_{k} ( t ) ) ) \times {δ}_{j} ( {I}_{{t}_{0}} ( {p}_{k} ( {t}_{0} ) ) )$$

with δ is the symbol of Kronecker and Hₜ(pₖ(t)) the weighting of the voxel position pₖ(t)thin the range [0;1] and such that:

$${H}_{t} ( {p}_{k} ( t ) ) = \{ \begin{matrix}\frac{{{U}_{t} ( {p}_{k} ( t ) )}^{β}}{{τ}^{β}} , & si 0 \leq {U}_{t} ( {p}_{k} ( t ) ) < τ \\ 1 , & otherwise\end{matrix}$$

where τ is a scalar parameter representative of the minimum value of the confidence measurements, β is a parameter that discriminates the lowest confidence measured values and Uₜ is the image of the confidence measurement map obtained in step 103.
More specifically, to minimize the cost function C, an estimate of the vector Δq is calculated iteratively from the formula:

Δq=−αJ^{T}H^{T}H[Iₜ(M(q^{k-1}(t)))−Iₜ_{₀}(M(q(t₀)))] (Eq. 1),

where:
α>0 represents the iteration pitch of the minimisation strategy;
q^{k-1}(t) represents an estimate of the vector of the positions of the vertices at time t at the iteration k−1 of the optimisation algorithm;
J is the Jacobian matrix associated with the cost function C, expressed in the form j=∇I.M I is the gradient of the intensity of the current image, which links the displacements of the external vertices Δq to the variation of the intensity I.

Indeed, a Taylor development of C(Δq) results in:

C(Δq)≈(HₜJΔq+Hₜ(Iₜ(M(q^{k-1}(t)))−Iₜ_{₀}(M(q(t₀)))))² (Eq. 2),

Then, using an additive optimisation using gradient descent, the equation Eq. 1 can be deduced directly from the equation Eq. 2.

We then combine, in a step 106, this estimation of the displacement of the vertices of the contour of the target Δq with internal displacements resulting from the simulation of the deformation of a mechanical mass-spring-damper system applied to the target.

The optimal displacement of the vertices of the contour of the target is thus estimated iteratively as follows :

qₖ(t)=qₖ₋₁(t)+Δq+Δd

(Eq. 3) where Δd is the vector of the internal displacements, Δq is an estimate of the displacement of the vertices of the target contour obtained by the equation (Eq. 1) and I estimate of the positions of the vertices at the iteration k−1 and at time t.

The displacement Δd associated with the mass-spring-damper system is obtained by integrating the forces fᵢ exerted on each vertex qᵢ via a semi-implicit integration scheme of Euler qi, where fᵢ is expressed as:

$${f}_{i} = {\sum }_{n = 0}^{{N}_{i}} {f}_{in} + {G}_{i} {\dot{q}}_{i}$$

with Nᵢ the number of neighboring vertices connected to the vertex qᵢ, Gᵢ, is the velocity damping coefficient associated with the vertex qᵢ and fᵢₙ is calculated using the following formulation:

fᵢⱼ=Kᵢⱼ(dᵢⱼ−dᵢⱼ^{init}) (qᵢ−qⱼ)+Dᵢⱼ(\dot{q}ᵢ−\dot{q}ⱼ)o(qᵢ−qⱼ)
with j=n and
   where the operator ° corresponds to the matrix product of Hadamard, dᵢⱼ dᵢⱼ^{init}·e respectively the distance between the vertice qᵢ and qⱼ in the current image and in the initial image, Kᵢⱼ is a scalar quantity representative of the stiffness of the spring which links the two vertices qᵢ and qⱼ and Dᵢⱼ is a damping coefficient.

In this particular embodiment of the invention, Kᵢⱼ and Dᵢⱼ are respectively assigned the values 3, 0 and 0, 1 regardless of the spring that binds two vertices and the value 2.7 is assigned to Gᵢ for all vertices. In a variant, it can be envisaged to set the values of the coefficients Kᵢⱼ, Dᵢⱼ and Gᵢ from images obtained by elastography.

It should be noted that the relative importance of internal displacements in relation to displacements of vertices of the contour obtained by minimising a cost function can be adjusted by varying the value of the iteration pitch a of the minimization strategy of equation Eq. 1.

In a variant of this particular embodiment of the invention, in the presence of an extended and/or very dark shaded portion PO, the importance of the displacements Δq with respect to the displacements Δd in the PO part is minimised, when estimating the optimal displacement of the vertices of the contour of the target, by weighting them.

In this way, we emphasise the mechanical model of internal displacement, which makes it possible to guarantee that the deformation applied to the contour remains physically realistic and thus to increase the resistance of the tracking process to any aberrations.

The equation Eq. 3 then becomes: qₖ(t)=qₖ₋₁(t)+γΔq+Δd (Eq. 3′), where γ is a weighting coefficient of the contribution of the displacements Δq with respect to displacements Δd.

In relation to FIG. 4, we now present an example of simplified structure of a device 400 for tracking a clinical image according to the invention. The device 400 implements the method for tracking a clinical image according to the invention which has just been described in connection with FIG. 1.

For example, the device 400 comprises a processing unit 410, equipped with a processor μ1 and driven by a computer program Pg1 420 stored in a memory 430 and implementing the method for tracking a clinical target according to the invention.

At initialisation, the code instructions of the computer program Pg1 420 are for example loaded into a RAM before being executed by the processor of the processing unit 410. The processor of the processing unit 110 implements the steps of the method described above, according to the instructions of the computer program 420.

In this exemplary embodiment of the invention, the device 400 comprises at least one unit (U1) for obtaining a segmentation of a contour of the target from the reference image, a unit (U2) for determining a region delimiting the interior of the segmented contour of the target in the reference image, a unit (U3) for obtaining a confidence measurement per image element in said determined region for the reference image and for the current image, a unit (U4) for adapting the reference image at least from the intensities of the current image and confidence measurements of the current image in the region of the target and a unit (U5) for deforming said contour by minimising a cost function based on an intensity difference between the current image and the reference image in the determined region, said cost function being weighted by the confidence measurements obtained for the image elements of the region and taking into account the intensities of the adapted reference image.

These units (U1, U2, U3, U4 and U5) are controlled by the processor μ1 of the processing unit 410.

The precision method for tracking a clinical target described above was evaluated on 4 referenced sequences of three-dimensional images obtained by ultrasound imaging, each containing an anatomical target, taken on volunteer patients not holding their breath.

Table 1 below presents the 4 sequences used for this evaluation.

TABLE 1

| Sequence | Type of mvt | shadows | Change in gain |
|---|---|---|---|
| PHA1 | TRANSLATION | yes | no |
| PHA2 | ROTATION | Yes | no |
| PHA3 | no | no | yes |
| PHA4 | TRANSLATION | yes | yes |

The targets of the sequences PHA1 and PHA4 are subjected to translational movements, that of the sequence PHA2 a rotational movement, while the target of the sequence PHA3 no movement.

In addition some targets are disturbed by:
the presence of localised shaded regions (PHA1, PHA2 and PHA4);
gain changes during acquisition generating overall brightness changes in the sequence (PHA3 and PH4).

Table 2 below compares the results obtained by the implementation of the method for tracking a clinical target according to the invention, measured as a deviation, in millimetres, between the estimated position of the four targets on images of sequences and that established by a panel of expert practitioners with other methods, such as the cost function SSD on its own and the cost function SSD weighted by confidence measurements.

TABLE 2

| Sequence | SSD | SSD + confidence | invention |
|---|---|---|---|
| PHA1 | | 5.36 ± 6.01 | 2.0 ± 1.7 |
| PHA2 | 10.6 ± 11.7 | 5.8 ± 6.8 | 2.48 ± 2.18 |
| PHA3 | 42 ± 46 | | |
| PHA4 | | 31 ± 41 | 2.4 ± 2.2 |

Note also that the method for tracking a clinical target according to the invention is more accurate and robust for any type of disturbance than other cost functions known from the prior art.

It goes without saying that the embodiments which have been described above have been given by way of purely indicative and non-limiting example, and that many modifications can be easily made by those skilled in the art without departing from the scope of the invention.

For example, the invention is not limited to target tracking in a three-dimensional image sequence, but also applies to a two-dimensional image sequence. In this case, the picture elements are pixels and the mesh elements are triangles.

An exemplary embodiment of the present disclosure improves the situation of the prior art.

An exemplary embodiment of the invention remedies the shortcomings of the state of the art mentioned above.

More specifically, an exemplary embodiment of the invention provides a clinical target tracking technique in a sequence of images that is robust regardless of the aberrations presented by the images of the sequence.

An exemplary embodiment of the invention also provides such a technique for tracking a clinical target that has increased accuracy.

Although the present disclosure has been described with reference to one or more examples, workers skilled in the art will recognize that changes may be made in form and detail without departing from the scope of the disclosure and/or the appended claims.

1. A method for tracking a clinical target in a current image of a sequence of digital medical images, obtained by an ultrasound or endoscopic imaging technique, with respect to a reference image of said sequence, a digital image of the sequence comprising image elements, said method comprising the following acts performed by an image processing device:
receiving the sequence of digital medical images;
obtaining a segmentation of a contour of said target from said reference image;
determining a zone delimiting the an interior of the segmented contour of the target in said reference image;
obtaining a confidence measurement per image element in said determined zone for said reference image and for said current image;
deforming said contour obtained by minimising a cost function based on an intensity difference between the current image and the reference image in the determined region, said cost function being weighted by the confidence measurements obtained for the image elements of the region; and
adapting the reference image at least from the intensities of the current image and the current image confidence measurements in the target region, and wherein the cost function takes into account the intensities of the adapted reference image.

2. The method for tracking a clinical target according to claim 1, wherein said cost function takes into account a weighting of the combined probability density of the intensities of the current image and the reference image by said confidence measures.

3. The method for tracking a clinical target according to claim 1, further comprising detecting at least one aberration portion in said reference image and in said current frame and wherein said aberration portion detected is taken into account in said obtaining a confidence measurement in said specific region to said reference image and said current image.

4. The method of tracking a clinical target according to claim 1, wherein the contour deformation further takes into account a mechanical model of internal deformation of the target for correcting said deformation resulting from the minimisation of a cost function and the deformation of the contour resulting from the minimisation of a cost function with respect to the deformation resulting from the mechanical model of internal deformation of the target in the said determined region is weighted.

5. A device for tracking a clinical target in a current image of a sequence of digital medical images, obtained by an ultrasound or endoscopic imaging technique, with respect to a reference image of said sequence, a digital image comprising image elements, the device comprising:
a processor; and
a non-transitory computer-readable medium comprising instructions stored thereon, which when executed by the processor configure the device to perform acts comprising:
receiving the sequence of digital medical images;
obtaining a segmentation of a contour of said target from said reference image;
determining a region delimiting an interior of the segmented contour of the target in said reference image;
obtaining a confidence measurement per image element in said determined region for said reference image and for said current image;
deforming said contour by minimizing a cost function based on an intensity difference between the current image and the reference image in the determined region, said cost function being weighted by the confidence measurements obtained for the image elements of the region; and
adapting the reference image at least from the intensities of the current image and the current image confidence measurements in the target region and wherein the cost function takes into account the intensities of the adapted reference image.

6. (canceled)

7. A non-transitory processor-readable recording medium on which is recorded a computer program comprising program code instructions for performing a method, when executed by a processor of an image processing device, for tracking a clinical target in a current image of a sequence of digital medical images, obtained by an ultrasound or endoscopic imaging technique, with respect to a reference image of said sequence, a digital image of the sequence comprising image elements, said instructions configuring the image processing device to perform acts comprising:
receiving the sequence of digital medical images;
obtaining a segmentation of a contour of said target from said reference image;
determining a zone delimiting an interior of the segmented contour of the target in said reference image;
obtaining a confidence measurement per image element in said determined zone for said reference image and for said current image;
deforming said contour obtained by minimising a cost function based on an intensity difference between the current image and the reference image in the determined region, said cost function being weighted by the confidence measurements obtained for the image elements of the region; and
adapting the reference image at least from the intensities of the current image and the current image confidence measurements in the target region, and wherein the cost function takes into account the intensities of the adapted reference image.
